(19) United States
(12) Patent Application Publication
(10) Pub. No.: US 2012/0224556 A1
(43) Pub. Date: Sep. 6, 2012

(54) METHOD AND DEVICE FOR TRANSMITTING A REFERENCE SIGNAL AND REFERENCE SIGNAL INFORMATION IN A COOPERATIVE MULTI-ANTENNA SENDING AND RECEIVING SYSTEM

(75) Inventors: Sungjun Yoon, Seoul (KR); Kyoungmin Park, Goyang-si (KR); Sungjin Suh, Seoul (KR)

(73) Assignee: PANTECH CO., LTD., Seoul (KR)

(21) Appl. No.: 13/508,854

(22) PCT Filed: Oct. 29, 2010
(86) PCT No.: PCT/KR10/07525

§ 371 Date: May 9, 2012

(30) Foreign Application Priority Data
Nov. 11, 2009 (KR) 10-2009-0108807

(51) Int. Cl. H04W 72/04

(52) U.S. Cl. 370/329

(57) ABSTRACT

Provided are a method and device for transmitting a reference signal and reference signal information in a cooperative multi-antenna sending and receiving system. Disclosed are a transmission method and device for resolving the problem whereby interference can occur between neighboring cells.

### CROSS-REFERENCE TO RELATED APPLICATIONS

This application is the National Stage Entry of International Application No. PCT/KR2010/007525, filed on Oct. 29, 2010 and claims priority from and the benefit of Korean Patent Application No. 10-2009-0108807, filed on Nov. 11, 2009, both of which are hereby incorporated by reference for all purposes as if fully set forth herein.

### BACKGROUND

1. Field

The present invention relates to a method and an apparatus for transmitting a reference signal and reference signal information in a coordinated multi-antenna transmission/reception system.

2. Discussion of the Background

With the development of a communication system, consumers such as enterprises and individuals have used highly various wireless terminals.

Accordingly, communication service providers create a new communication service market for wireless terminals, and continuously attempt to expand an existing communication service market by providing a reliable and cheap service.

### SUMMARY

The present invention discloses a method and an apparatus for transmitting a reference signal and reference signal information in a coordinated multi-antenna transmission/reception system.

Further, the present invention discloses a method and an apparatus for removing or minimizing interference with a neighbor cell when an uplink reference signal is transmitted in a coordinated multi-antenna transmission/reception system.

Moreover, the present invention provides a method and an apparatus for identifying whether a base station is included in a coordinated base station set and transmitting a reference signal and reference signal information in a wireless communication system.

Furthermore, the present invention provides a method and an apparatus for scheduling in such a manner that it is identified whether the base station is included in a coordinated base station set and transmits a reference signal and reference signal information in a wireless communication system.

In accordance with an aspect of the present invention to solve the above-mentioned problem, there is provided a method of transmitting reference signal information in a coordinated multi-antenna transmission/reception system, the method including determining one or more of reference signal transmission periods and offsets in consideration of reference signal transmission periods and offsets of other Base Stations (BSs) within a coordinated BS set; and transmitting information on the determined one or more of the reference signal transmission periods and offsets or reference signal information indicating one or more of the determined reference signal transmission periods and offsets to a reference signal transmission side.

In accordance with another aspect of the present invention, there is provided a method of transmitting a reference signal in a coordinated multi-antenna transmission/reception system, the method including receiving reference signal information determined such that interference with another BS within a coordinated BS set is not generated or is minimized; and transmitting the reference signal according to the reference signal information.

In accordance with another aspect of the present invention, there is provided an apparatus for transmitting reference signal information in a coordinated multi-antenna transmission/reception system, the apparatus including a reference signal information determiner for determining one or more of its own reference signal transmission periods and offsets such that a plurality of BSs within a coordinated BS set do not simultaneously receive a reference signal in an equal subframe in consideration of reference signal transmission periods and offsets of other BSs within the coordinated BS set, and determining reference signal information indicating one or more of the determined reference signal transmission periods and offsets; and a reference signal information transmitter for transmitting the determined reference signal information to a reference signal transmission side.

In accordance with another aspect of the present invention, there is provided an apparatus for transmitting a reference signal in a coordinated multi-antenna transmission/reception system, the apparatus including a reference signal information receiver for receiving reference signal information on one or more of reference signal transmission periods and offsets from a BS within a coordinated BS set; a reference signal transmission period and offset determiner for determining a reference signal transmission period and offset for a corresponding BS by using the received reference signal information configured such that the reference signal is not simultaneously transmitted in a subframe in which the reference signal is transmitted to another BS within the coordinated BS set; and a reference signal transmitter for transmitting the reference signal in a corresponding subframe according to the determined reference signal transmission period and offset.

### BRIEF DESCRIPTION OF THE DRAWINGS

FIG. 1 is a diagram illustrating a wireless communication system to which the present invention is applied.

FIG. 2 is a diagram illustrating a coordinated multi-point transmission/reception system to which the present invention is applied.

FIG. 3 illustrates a structure of subframes including an uplink reference signal in a wireless communication system to which the present invention is applied.

FIG. 4 is a flowchart of an SRS (Sounding Reference Signal) transmitting method in the wireless communication system to which the present invention is applied.

FIG. 5 is a flowchart of an enhanced SRS transmitting method for a coordinated multi-antenna transmission/reception system according to an embodiment of the present invention.

FIG. 6 illustrates a time division scheme by which the enhanced SRS is not transmitted between neighbor cells on a time axis by using different subframes transmitting the enhanced SRS through the time division scheme for two cells in the wireless communication system according to the present invention.

FIG. 7 illustrates a configuration of a reference signal information transmitting apparatus according to an embodiment of the present invention.

FIG. 8 illustrates a configuration of a reference signal transmitting apparatus according to an embodiment of the present invention.

### DETAILED DESCRIPTION OF THE ILLUSTRATED EMBODIMENTS

Hereinafter, exemplary embodiments of the present invention will be described with reference to the accompanying drawings. In the following description, the same elements will be designated by the same reference numerals although they are shown in different drawings. Further, in the following description of the present invention, a detailed description of known functions and configurations incorporated herein will be omitted when it may make the subject matter of the present invention rather unclear.

In addition, terms, such as first, second, A, B, (a), (b) or the like may be used herein when describing components of the present invention. Each of these terminologies is not used to define an essence, order or sequence of a corresponding component but used merely to distinguish the corresponding component from other component(s). It should be noted that if it is described in the specification that one component is “connected,” “coupled” or “joined” to another component, a third component may be “connected,” “coupled,” and “joined” between the first and second components, although the first component may be directly connected, coupled or joined to the second component.

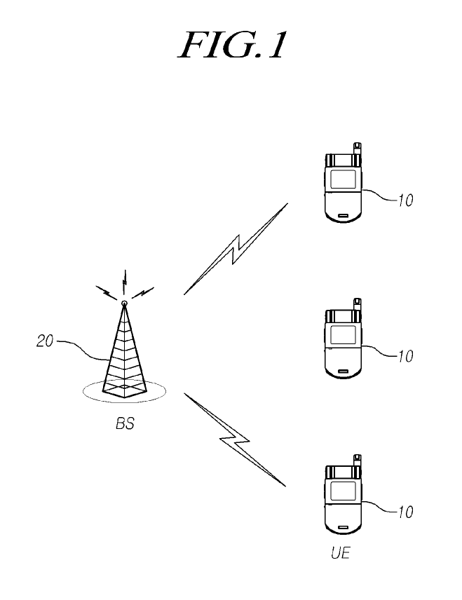

FIG. 1 is a diagram illustrating a wireless communication system to which the present invention is applied. The wireless communication system is widely arranged to provide various communication services such as voice, packet data, etc.

Referring to FIG. 1, the wireless communication system includes a User Equipment (UE) 10 and a Base Station (BS) 20. The UE 10 and the BS 20 use reference signal information and a technology for transmitting a reference signal using the reference signal information in a coordinated multi-antenna transmission/reception system which will be discussed in the following description.

The UE 10 in this specification is a generic concept indicating a user terminal in wireless communication, and should be interpreted as a concept including all of a MS (Mobile Station), a UT (User Terminal), a SS (Subscriber Station), a wireless device, etc. in a GSM as well as a UE (User Equipment) in a WCDMA, a LTE, an HSPA, etc.

The BS 20 or a cell generally refers to a fixed station communicating with the UE 10, and may be referred to as other terms such as a Node-B, an eNB (evolved Node-B), a BTS (Base Transceiver System), an access point, a relay node, etc.

That is, in this specification, the BS 20 or the cell should be interpreted as a generic concept indicating some areas covered by a BSC (Base Station Controller) in a CDMA and a Node-B in a WCDMA, and is a concept including various coverage areas such as communication ranges of a mega cell, a macro cell, a micro cell, a pico cell, a femto cell, and a relay node.

The UE 10 and the BS 20 in this specification are used as a generic meaning, which are transmitting/receiving subjects used to implement a technology or a technological idea described in the present disclosure, and they are not limited by a specifically designated term or word.

A multiple access scheme applied to a wireless communication system has no limitation, and the wireless communication system can use various multiple access schemes such as a CDMA (Code Division Multiple Access), a TDMA (Time Division Multiple Access), an FDMA (Frequency Division Multiple Access), an OFDMA (Orthogonal Frequency Division Multiple Access), an OFDM-FDMA, an OFDM-TDMA, and an OFDM-CDMA.

A TDD (Time Division Duplex) scheme corresponding to a transmission using different times may be used for an uplink transmission and a downlink transmission, or an FDD (Frequency Division Duplex) scheme corresponding to a transmission using different frequencies may be used for an uplink transmission and a downlink transmission.

An embodiment of the present invention may be applied to resource allocations of an asynchronous wireless communication field evolving into an LTE (Long Term Evolution) and an LTE-advanced via a GSM, a WCDMA, and an HSPA, and a synchronous wireless communication field evolving into a CDMA, a CDMA-2000, and a UMB. The present invention should not be interpreted as a limited and restricted concept to a specific wireless communication field, but should be interpreted as a concept including all technical fields, to which ideas of the present invention can be applied.

In a beyond 3G communication technology which is currently discussed, the UE transfers channel information to the BS by transmitting a reference signal similar to a pilot used in a conventional 2G system to an uplink. The reference signal can be selected to be operated in various modes according to a period, a frequency band bandwidth, a start position, a hopping pattern manner, etc., and is determined by cell-specific parameters or UE-specific parameters. The cell-specific parameter refers to a parameter distinguishable between BSs and the UE-specific parameter refers to a parameter distinguishable between users.

A frequency bandwidth, a period, and a subframe configuration of an uplink reference signal currently discussed are determined by the cell-specific parameters. All UEs included in a predetermined cell receive the same parameter, and are operated in a mode determined by the received cell-specific parameters.

Further, in the currently discussed beyond 3G communication technology, there is the Coordinated Multi-Point transmission/reception system (CoMP) or the coordinated multi-antenna transmission system. When a plurality of BSs attempt to provide a service to one user in the coordinated multi-point transmission/reception system, the BSs provide the service by allocating the same frequency resource in the same time.

In the coordinated multi-point transmission/reception system, the BS and the UE are allocated the same frequency resource in the same time and transmit/receive the frequency resource when transmitting/receiving coordinated data. That is, a plurality of BSs selected as coordinated BSs in the same time transmit data to one user by using the same frequency resource.

UEs using such a communication scheme may be UEs having a lower signal intensity due to their positions in a boundary region of cells in comparison with cells located in a central region of the cells, and may be UEs which can receive a signal from a plurality of BSs since the UEs are relatively close to other BSs.

Accordingly, a plurality of BSs cooperatively transmit a signal to the UEs, so that each UE can achieve better reception performance in comparison with a case where one conventional BS transmits the signal to the UEs.

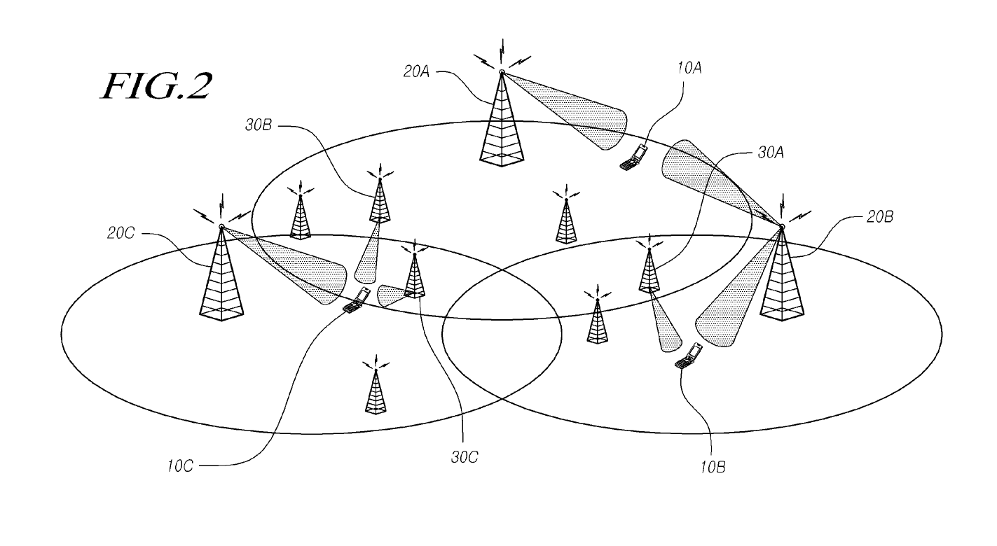

FIG. 2 is a diagram illustrating a coordinated multi-point transmission/reception system to which the present invention is applied.

Referring to FIG. 2, in the coordinated multi-point transmission/reception system evolved from a conventional technology in which one UE is connected to one BS to transmit/receive data, one UE transmits/receives cooperatively with one or more BSs so that more increased data efficiency can be obtained and the UE can receive a better quality service.

Referring to FIG. 2, one UE 10A can be simultaneously connected to two or more BSs 20A and 20B and receive a service, or connected to a BS having the best channel according to a channel state based on a predetermined time period and receive a service.

A wireless communication system can have relays or relay nodes 30A and 30B between the UE 10 and the BS 20. The relays 30A and 30B can have their physical cell IDs and transmit their synchronization channels and reference symbols or reference signals, and cannot generate a new cell without a separated cell IP.

Further, another UE 10B can be simultaneously connected to one BS 20B and one relay 30A and receive a service. Another UE 10C can be simultaneously connected to one BS 20C and two or more relays 30B and 30C and receive a service. The UE 10C also can be simultaneously connected to one BS 20C and two or more relays 30A and 30B and receive a service. Hereinafter, coordinated relays 30A and 30B are considered as a type of coordinated BSs in this specification.

The UEs 10A, 10B, and 10C and the BSs 20A, 20B, and 20C shown in FIG. 2 correspond to the UE 10 and the BS 20 shown in FIG. 1. Accordingly, when the UEs are needed to be distinguished in this specification, they are represented by reference numerals 10A, 10B, and 10C. When the UEs are not needed to be distinguished, they are represented as a reference numeral 10. Similarly, when the BSs are not needed to be distinguished, they are represented by a reference numeral 20. Similarly, when the relays are not needed to be distinguished, they are represented by a reference numeral 30.

Alternatively, when a beam forming or a precoding value is set in consideration of only a channel state with a conventional BS receiving a service in a beam forming or a precoding, the coordinated multi-point transmission/reception system can set the beam forming or the precoding value by estimating an interference value or an estimation value for the channel state with a neighbor BS.

When the BS 20 and the UE 10 transmit/receive coordinated data in the coordinated multi-point transmission/reception system, the BS and the UE are allocated the same frequency resource in the same time and transmit/receive the frequency resource. That is, the plurality of BSs 20A and 20B selected as the coordinated BSs in the same time transmit/receive data to/from one UE 10A by using the same frequency resource. Accordingly, the BS selected as the coordinated BS should be a BS having a better channel performance for a predetermined frequency band of one UE.

The UE 10 can grasp a channel state for each antenna of each BS 20 by analyzing reference signals transmitted from each BS 20. After grasping each channel state, the UE 10 directly or indirectly feeds back information on the channel state to each BS 20. The BS 20 or a higher layer having received the feedback of the information selects BSs (e.g. 20A and 20B of FIG. 2) having the better channel performance and configures a coordinated BS set with the selected BSs, and the BSs included in the coordinated BS set initiate coordinated transmission/reception.

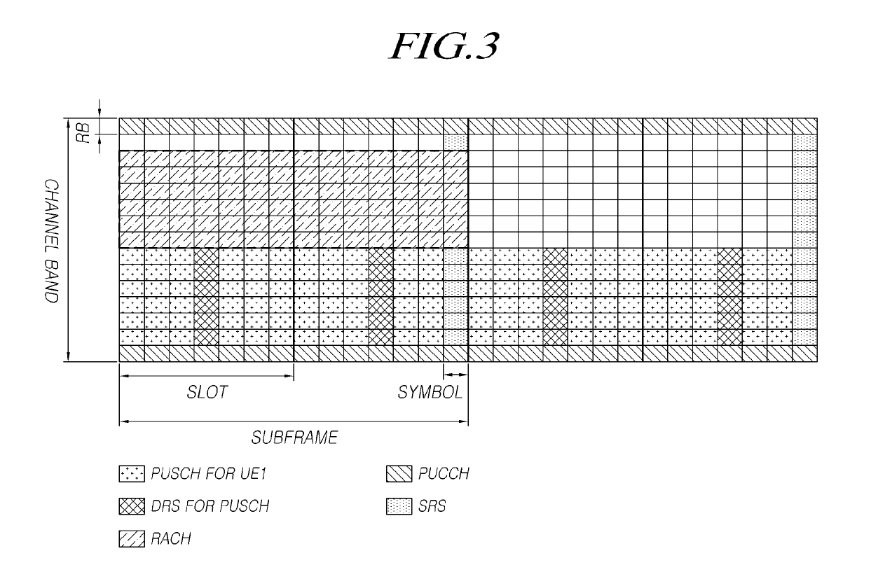

FIG. 3 illustrates a configuration of subframes including an uplink reference signal in a wireless communication system to which the present invention is applied.

Referring to FIG. 3, uplink reference signals allocated to a subframe may include a DM-RS (Demodulation Reference Signal) and an SRS (Sounding Reference Signal). The SRS is a type of uplink reference signal to transmit uplink channel information to the BS by the UE in the wireless communication system.

The SRS should be able to transfer uplink channel information for an entire band including bands having a probability of being used by the UE as well as bands to be used by each UE. That is, the UE 10 should transmit the SRS to the BS over the entire band of a sub carrier.

As shown in FIG. 3, the SRS may be transmitted once for each subframe, or may be transmitted once for every N subframe or k times for every N subframe by the cell-specific parameter. Here, frequently transmitting the SRS may mean an environment allowing a rapid change in a channel state to the extent that information can be more rapidly obtained. On the other hand, infrequently transmitting the SRS may mean that there is a stable channel environment due to no large change in the uplink channel so that there is no need to frequently transmit the SRS.

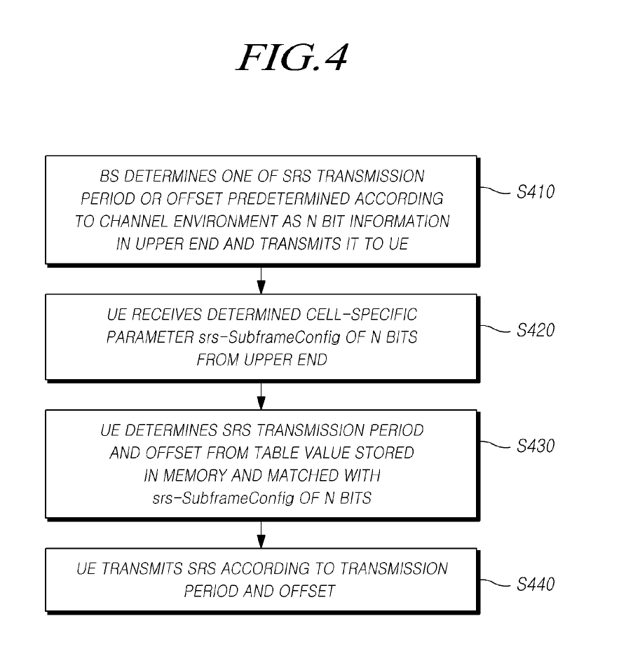

FIG. 4 is a flowchart of an SRS (Sounding Reference Signal) transmitting method in the wireless communication system to which the present invention is applied.

Referring to FIG. 4, for each BS (cell) 20, each BS (cell) 20 determines one of prearranged SRS transmission periods or offsets as 4-bit information according to a channel environment in a higher side and transmits it to the UE 10 in step S410. The number of cases of prearranged SRS transmission periods and offsets is 13 in FDD (Frequency Division Duplex) and 15 in TDD (Time Division Duplex), which indicates representative cases for a subframe transmitting the SRS for each subframe with respect to one radio frame including 10 subframes.

The UE 10 receives the cell-specific 4-bit parameter srs-SubframeConfig determined in the higher side in step S420.

The UE 10 determines the SRS transmission period and offset from a table value, which is stored in the memory, matched with a value of the received 4-bit srs-SubframeConfig information in step S430.

Next, the UE 10 transmits the SRS to a corresponding subframe according to the determined transmission period and offset in step S440.

[Table 1] below is configured with prearranged SRS transmission periods and offsets in a case of one FDD of the wireless communication system.

TABLE 1

| | | Configuration | |
|---|---|---|---|
| srsSubframe- | | Period T_{SFC} | Transmission offset |
| Configuration | Binary | (subframes) | Δ_{SFC} (subframes) |
| 0 | 0000 | 1 | {0} |
| 1 | 0001 | 2 | {0} |
| 2 | 0010 | 2 | {1} |
| 3 | 0011 | 5 | {0} |
| 4 | 0100 | 5 | {1} |
| 5 | 0101 | 5 | {2} |
| 6 | 0110 | 5 | {3} |
| 7 | 0111 | 5 | {0, 1} |
| 8 | 1000 | 5 | {2, 3} |
| 9 | 1001 | 10 | {0} |
| 10 | 1010 | 10 | {1} |
| 11 | 1011 | 10 | {2} |
| 12 | 1100 | 10 | {3} |
| 13 | 1101 | 10 | {0, 1, 2, 3, 4, 6, 8} |
| 14 | 1110 | 10 | {0, 1, 2, 3, 4, 5, 6, 8} |
| 15 | 1111 | Reserved | reserved |

As shown in [Table 1], there are a total of fifteen SRS subframe configurations, and the SRS is more frequently transmitted when the channel is quickly changed and the SRS is more infrequently transmitted when the channel environment is slowly changed based on the channel environment.

When the higher side transmits the SRS with a no. 7 subframe configuration of [Table 1] in consideration of the channel environment of each BS, the UE 10 receives 4-bit srs-SubframeConfig, which is “0111”, from the BS 20. It means that the SRS is transmitted to only 0^{th} and 1^{st} subframes based on a five-subframe period in the table, so that the UE 10 transmits the SRS to the last OFDM symbol in each corresponding subframe.

However, in the aforementioned coordinated multi-point transmission/reception system shown in FIG. 2, when the UE 10 transmits the SRS to a plurality of BSs within the coordinated BS set, that is, when the UE 10 included in each BS transmits the SRS according to the steps of the transmitting method in consideration of only the channel environment, a serious interference problem occurs since each BS receives SRS information from the UE 10 included in several BSs in the same time and the same frequency band.

For example, the BS A 20A and the BS B 20B refer to the coordinated BS set in the coordinated multi-point transmission/reception system. Further, it is considered that the BS A 20A includes the UE a 10A and the UE a 10A transmits the SRS with a no. 3 subframe configuration (transmits the SRS to the 0^{th} subframe based on the five-subframe period) of [Table 1], and the BS B 20B includes the UE b 10B and the UE b 10B transmits the SRS with a no. 7 subframe configuration (transmits the SRS to the 0^{th} and 1^{st} subframes based on the five-subframe period) of [Table 1].

In this case, the BS B 20B receives SRS information from the UE a 10A of the BS A 20A and the UE b 10B of the BS B 20B, and both UEs 10A and 10B simultaneously transmit the SRS in the 0^{th} subframe based on every five-subframe period, so that a serious interference problem is generated.

Particularly, since the UE b 10B is closer to the UE a 10A in comparison with the BS B 20B, an SRS from the UE a 10A is lost in an SRS from the UE b 10B because power of the received signal from the UE a 10A is stronger than that from the UE b 10B. Accordingly, it is difficult to detect the SRS signal from the UE a 10A.

For this reason, it is required to minimize the interference problem by distinguishing the SRS transmissions for each BS within the coordinated BS set.

Accordingly, the present invention intends to provides a method of variously configuring a cell-specific SRS subframe configuration table, etc. for the SRS transmission period and offset in transmitting the uplink SRS in the coordinated multi-point transmission/reception system.

Particularly, the present invention describes in detail a method of scheduling such that respective BSs within the coordinated BS set, which is a set of BSs to which one UE transmits the same reference signal under a cell-specific SRS subframe configuration, do not simultaneously transmit the SRS in the same subframe.

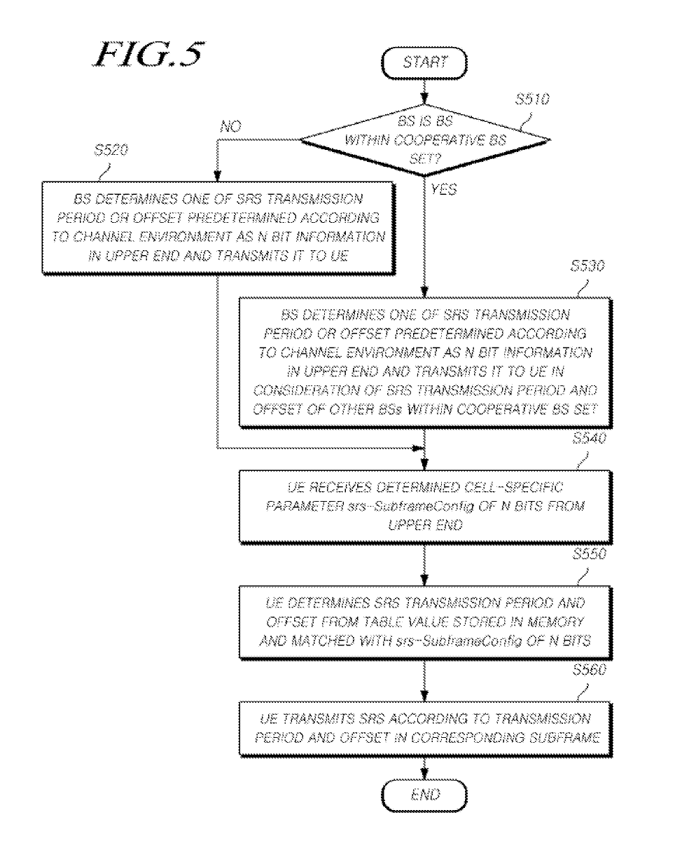

FIG. 5 is a flowchart of an enhanced SRS transmitting method for a coordinated multi-antenna transmission/reception system according to an embodiment of the present invention.

Referring to FIG. 5, it is first determined (identified) whether each BS (20A to 20C of FIG. 2) is a BS within the coordinated BS set in step S510. At this time, a core network corresponding to a higher layer identifies whether each BS (20A to 20C of FIG. 2) is the BS included in the coordinated BS set and then can inform the corresponding BS of a result of the identification.

If each BS (20A to 20C of FIG. 2) is not the BS included in the coordinated BS set, the BS 20 determines one of the prearranged SRS transmission periods and offsets in consideration of only the channel environment and transmits N-bit (N is a natural number equal to or larger than 1) srs-SubframeConfig information to the UE 10 in step S520.

If each BS (20A to 20C of FIG. 2) is the BS included in the coordinated BS set, the BS 20 determines one of the prearranged SRS transmission periods and offsets in consideration of SRS transmission periods and offsets of other BSs within the coordinated BS set as well as the channel environment and transmits the N-bit srs-SubframeConfig information corresponding to the determination to the UE in step S530.

At this time, the BS 20 can transmit the srs-SubframeConfig information to UEs within their cells through a broadcasting channel (BCH). Alternatively, the BS 20 can transmit the srs-SubframeConfig information to UEs within their cells by using a dedicated channel.

That is, the determination of the SRS transmission period and offset according to the present invention includes scheduling such that all BSs within the coordinated BS set do not receive the SRS in the same subframe at the same time.

For example, when it is assumed that there exist three BSs within the coordinated BS set, it is scheduled such that the BS (cell) A 20A transmits the SRS to 0^{th} and 1^{st} subframes based on the five-subframe period, the BS (cell) B 20B transmits the SRS to 2^{nd} and 3^{rd} subframes based on the five-subframe period, and the BS (cell) C 20C transmits the SRS to a 4^{th} subframe based on the five-subframe period.

At this time, in consideration of the channel environment, the higher side (e.g. BS or core network) schedules such that the BS (cell) of which the channel is more frequently changed more frequently transmits the SRS in comparison with the BS of which the channel is infrequently changed.

Accordingly, the BS C 20C according to an embodiment of the present invention may refer to a BS of which the channel environment is less frequently changed in comparison with other BSs A and B 20A and 20B.

Meanwhile, a current LTE system defines a total of 15 SRS transmission periods and offsets in the FDD scheme and a total of 14 SRS transmission periods and offsets in the TDD scheme, and configures them as 4-bit information.

According to an embodiment of the present invention, the above information is configured by N bits in an enhanced SRS transmitting method for the coordinated multi-antenna transmission/reception system. At this time, N may be set to 4. Meanwhile, N may be set to a number equal to or larger than 5 and used in order to further diversify a combination for scheduling such that all BSs within the coordinated BS set do not receive the SRS in the same subframe at the same time by defining more various types of transmission periods and offsets.

That is, embodiments of the present invention can define more number of cases of prearranged SRS transmission periods and offsets by setting the N bits to 5 bits or larger. Further, cases of the combination for scheduling such that all BSs within the coordinated BS set do not receive the SRS in the same subframe at the same time can be more diversified.

However, when N is too large, the number of corresponding bits is increased when each BS transmits N-bit srs-SubframeConfig information determined in the higher side to the UE included in the BS, and thus overheads can be increased. Accordingly, it is needed to properly control the number of bits of the srs-SubframeConfig information.

For example, when N is 5, 32 prearranged SRS transmission periods and offsets, which are double that of a case of using 4 bits, can be used. For example, in a case where N is 4, when the SRS is transmitted based on the five-subframe period, offsets are {0}, {1}, {2}, {3}, {0,1}, and {2,3}. However, in a case where N is 5, when the SRS is transmitted based on the five-subframe period, offsets can be added from a part of {4}, {0,2}, {0,3}, {0,4}, {1,2}, {1,3}, {1,4}, {2,4}, {3,4}, {0,1,2}, {0,1,3}, {0,1,4}, {0,2,3}, {0,2,4}, {0,3,4}, {1,2,3}, {1,2,4}, {1,3,4}, and {2,3,4} for more various combinations if necessary.

For also another subframe period, for example, a ten-subframe period, some available offset configurations can be added if necessary. That is, in consideration of the added SRS transmission period and offset according to the present invention, an extended table from [Table 1] is constructed and each UE can store the table in a memory.

The UE 10 receives the cell-specific N-bit parameter srs-SubframeConfig determined in the higher layer from the BS to which the UE belongs in step S540.

Next, the UE 10 determines the SRS transmission period and offset from a table value, which is stored in the memory, matched with a value of the N-bit srs-SubframeConfig information in step S550.

Next, the UE 10 transmits the SRS in each corresponding subframe according to the SRS transmission period and offset determined in step S550 in step S560.

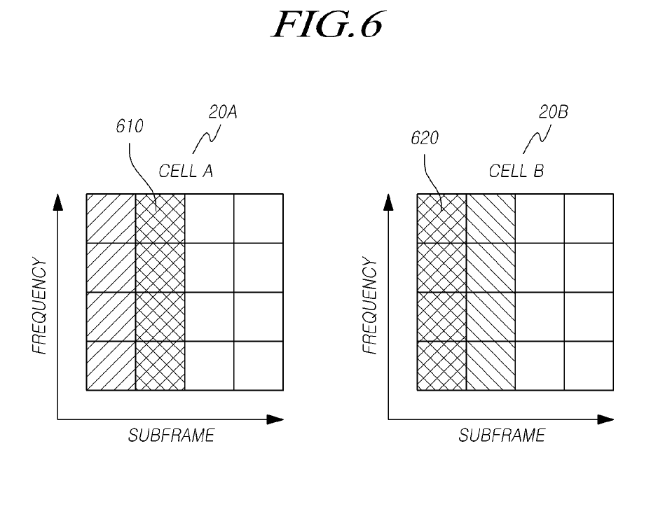

FIG. 6 illustrates a time division scheme by which the enhanced SRS is not transmitted between neighbor cells on a time axis by using different subframes transmitting the enhanced SRS through the time division scheme for two cells in the wireless communication system according to the present invention.

Referring to FIG. 6, the UEs do not provide interference to each other or can minimize the interference due to the SRS time-divided by the neighbor cell (BS) since the UE b 10B transmits no signal in a position of a subframe 610 in which the UE a 10A included in the BS A 20A transmits the SRS and the UE a 10A included in the BS A 20A transmits no signal in a position of a subframe 620 in which the UE b 10B included in the BS B 20B transmits the SRS.

Hereinafter, a method of constructing the aforementioned prearranged SRS transmission periods and offsets as a table and transmitting/receiving them as N-bit information, which is not need to be stored, will be described.

When the wireless communication system has more bits to be used according to a system implementation, the cases of combinations for scheduling such that all BSs within the coordinated BS set do not simultaneously transmit the SRS in the same subframe can be expended to all cases by more flexibly configuring the information for the transmission period and offset with a total of 10 bits.

In a method of configuring the transmission period and offset with a total of ten bits, a bit value is set to “1” when the SRS is transmitted in a corresponding subframe and the bit value is set to “0” when the SRS is not transmitted in the corresponding subframe based on an assumption that 10 frames included in one radio frame correspond to one bit.

For example, when a value of 10 bits is “1001010010”, the SRS is transmitted only to 0^{th}, 3^{rd}, 5^{th}, and 8^{th} subframes having a bit value of “0”.

In this case, there are an advantage of expanding cases of combinations available in scheduling to almost all of cases and an advantage of not requiring constructing cases of the SRS transmission periods and offsets as a table and storing the table in a memory. However, nearly double a number of bits are transmitted so that overheads may be increased.

Accordingly, the higher side (e.g. BS and core network) should set the number of bits indicating the cases of the SRS transmission periods and offsets in consideration of overheads which may be generated.

Through the embodiments described above, interference between neighbor cells can be minimized when the uplink SRS is transmitted in the coordinated multi-antenna transmission/reception system where one UE is required to simultaneously transmit the same reference signal to a neighbor cell as well as to a serving cell in which a corresponding user is located and with which the corresponding user mainly performs a transmission/reception.

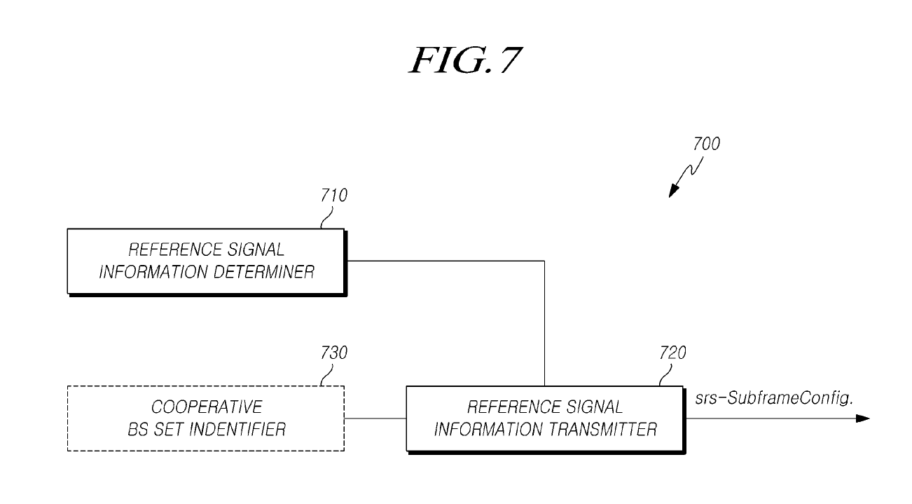

FIG. 7 illustrates a configuration of a reference signal information transmitting apparatus according to an embodiment of the present invention.

The reference signal transmitting apparatus according to an embodiment of the present invention can be implemented in an inside of the BS (or eNB) or as a part of the BS when the reference signal is the uplink reference signal such as the SRS, and the reference signal transmitting apparatus can be implemented in the UE when the reference signal is a downlink reference signal but the present invention is not limited thereto.

Referring to FIG. 7, the reference signal transmitting apparatus 700 may include a reference signal information determiner 710 for determining reference signal information and a reference signal information transmitter 720 for transmitting the determined reference signal information to a transmission side, and may selectively further include a coordinated BS set identifier 730.

At this time, the reference signal information may be information on one or more of the transmission periods and transmission offsets or N-bit srs-SubframeConfig information which can determine the transmission period and offset of the reference signal, but the present invention is not limited thereto.

The reference signal information determiner 710 performs a function of determining the information on the reference signal transmission period and offset. Particularly, when the BS is a BS within the coordinated BS set, the BS determines its own reference signal transmission period and/or offset in consideration of reference signal transmission periods and offsets of other BSs within the coordinated BS set, and can selectively determine N-bit srs-SubframeConfig information which can indicate the reference signal transmission period and/or offset.

At this time, when the BS determines its own reference signal transmission period and offset in consideration of the reference signal transmission periods and offsets of other BSs within the coordinated BS set, the BS may further schedule such that all BSs within the coordinated BS set do not receive the same reference signal in the same subframe at the same time.

The reference signal transmitter 720 performs a function of transmitting information indicating the determined reference signal transmission period and/or offset of the BS, that is, N-bit srs-SubframeConfig information which is reference signal information to the UE. At this time, the N-bit srs-SubframeConfig information can be transmitted through a broadcasting channel (BCH) and transmitted to UEs within the cell by using a dedicated channel.

The coordinated BS set identifier 730 performs a function of identifying whether the coordinated BS set identifier 730 is a BS included in the coordinated BS set for the corresponding UE. Such an identification procedure may be implemented autonomously by the BS or implemented using a notice from a core network which is a higher layer.

In the N-bit srs-SubframeConfig information which is the reference signal information, N may be 4 bits or 5 bits, but the present invention is not limited thereto.

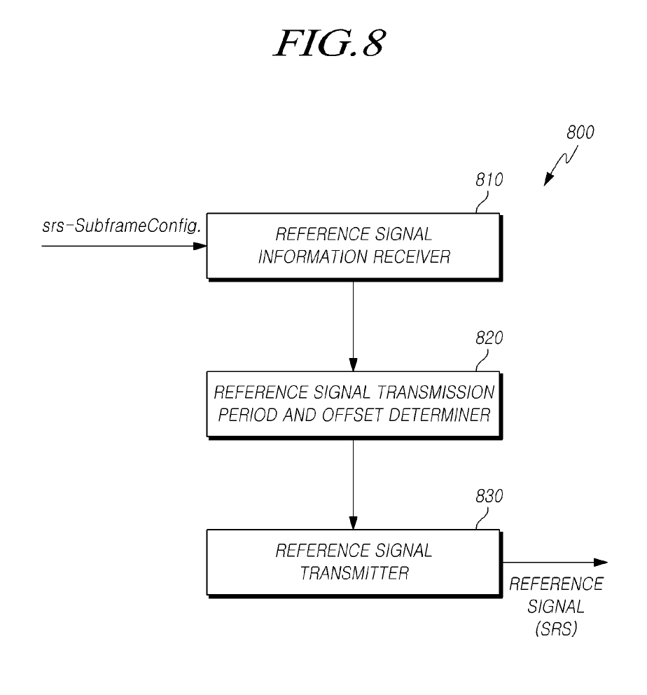

FIG. 8 illustrates a configuration of a reference signal transmitting apparatus according to an embodiment of the present invention.

The reference signal transmitting apparatus of FIG. 8 refers to an apparatus for receiving reference signal information indicating the reference signal transmission period and/or offset from the BS and then generating and transmitting the reference signal according to the received reference signal information, and can be referred to as a “reference signal information receiving apparatus”.

The reference signal transmitting apparatus according to this embodiment may be implemented as the UE, implemented in an inside of the UE, or implemented as a separate apparatus interworking with the UE when the reference signal is the SRS, but the present invention is not limited thereto. Further, the reference signal transmitting apparatus may be implemented as the BS (or eNB) when the reference signal is the downlink reference signal.

The reference signal transmitting apparatus 800 of FIG. 8 may include a reference signal information receiver 810, a reference signal transmission period and offset determiner 820, and a reference signal transmitter 830.

The reference signal information receiver 810 receives the N-bit srs-SubframeConfig which is the reference information as the information on the reference signal transmission period and/or offset from the BS to which the UE belongs. At this time, the BS may be one of BSs included in the coordinated BS set.

The srs-SubframeConfig which is the reference signal information may be 4-bit or 5-bit information, and the information uses the same configuration as the aforementioned configuration.

At this time, srs-SubframeConfig which is the reference signal information indicates information scheduled such that all BSs within the coordinated BS set do not receive the reference signal in the same subframe at the same time.

The reference signal transmission period and offset determiner 820 performs a function of determining its own reference signal transmission period and offset by using the received reference signal information. Specifically, the reference signal transmission period and offset determiner 820 can determine the SRS transmission period and offset from the N-bit srs-SubframeConfig value and a table value, which is stored in the memory, matched with the a value of the N-bit srs-SubframeConfig information.

At this time, the SRS transmission period and offset is determined such that the reference signal is not simultaneously transmitted in a subframe transmitting the reference signal to other BSs within the coordinated BS set.

The reference signal transmitter 830 performs a function of transmitting the reference signal in a corresponding subframe according to the transmission period and offset determined by the reference signal transmission period and offset determiner 820.

Although the embodiments have been described with reference to the drawings, the present invention is not limited thereto.

Even though the SRS has been described as an example of the uplink reference signal in the embodiments, the present invention is not limited thereto and the present invention may be applied to any uplink reference signal at the present or in the future.

The aforementioned embodiments have described the scheduling through the time division by which all BSs within the coordinated BS set do not simultaneously transmit the SRS in the same subframe when the SRS transmission period and offset are determined, but the present invention is not limited thereto.

A scheme of transmitting the SRS to neighbor cells without interference between the neighbor cells includes a frequency division scheme and a code division scheme as well as the time division scheme. In the frequency division scheme, each UE transmits a reference signal in all determined bands through different allocations of frequency resources through which the reference signal is transmitted, and the frequency resources are properly allocated such that neighbor cells do not transmit the reference signal with the same frequency resource. In the code division scheme, neighbor cells do not provide interference to each other since reference signals are distinguished by codes for the neighbor cells.

To this end, each BS transmits information on a frequency band or a used code together with the SRS transmission period and offset to corresponding UEs, and a corresponding UE transmits the SRS to each BS by using a corresponding frequency band or code for the SRS transmission period and offset, so that the interference may be minimized.

1. A method of transmitting reference signal information in a coordinated multi-antenna transmission/reception system, the method comprising:
determining one or more of reference signal transmission periods and offsets in consideration of reference signal transmission periods and offsets of other Base Stations (BSs) within a coordinated BS set; and
transmitting information on the determined one or more of the reference signal transmission periods and offsets or reference signal information indicating one or more of the determined reference signal transmission periods and offsets to a reference signal transmission side.

2. The method as claimed in claim 1, wherein determining of the one or more of the reference signal transmission periods and offsets comprises determining one or more of the reference signal transmission periods and offsets in consideration of a channel environment.

3. The method as claimed in claim 2, wherein the reference signal is an SRS (Sounding Reference Signal).

4. The method as claimed in claim 3, wherein transmitting of the information on the determined one or more of the reference signal transmission periods and offsets or the reference signal information indicating the one or more of the determined reference signal transmission periods and offsets to the reference signal transmission side comprises transmitting information of N bits indicating the one or more of the determined reference signal transmission periods and offsets to the reference signal transmission side.

5. The method as claimed in claim 4, wherein N is set to 4, 5, 6, 7, 8, 9, or 10.

6. A method of transmitting a reference signal in a coordinated multi-antenna transmission/reception system, the method comprising:
receiving reference signal information determined such that interference with another Base Station (BS) within a coordinated BS set is not generated or is minimized; and
transmitting the reference signal according to the reference signal information.

7. The method as claimed in claim 6, wherein transmitting of the reference signal comprises transmitting the reference signal to a different subframe of the BS from that of another BS within the coordinated BS set.

8. The method as claimed in claim 7, wherein the reference signal is an SRS (Sounding Reference Signal).

9. The method as claimed in claim 7, wherein, in receiving of the reference signal information, the reference signal information is information on one of reference signal transmission periods and offsets determined considering one or more of reference signal transmission periods and offsets, and channel environments of other BSs within the coordinated BS set or information of N bits indicating one or more of the determined reference transmission periods and offsets.

10. An apparatus to transmit reference signal information in a coordinated multi-antenna transmission/reception system, the apparatus comprising:
a reference signal information determiner to determine one or more of its own reference signal transmission periods and offsets such that a plurality of Base Stations (BSs) within a coordinated BS set do not simultaneously receive a reference signal in an equal subframe in consideration of reference signal transmission periods and offsets of other BSs within the coordinated BS set, and to determine reference signal information indicating one or more of the determined reference signal transmission periods and offsets; and
a reference signal information transmitter to transmit the determined reference signal information to a reference signal transmission side.

11. An apparatus to transmit a reference signal in a coordinated multi-antenna transmission/reception system, the apparatus comprising:
a reference signal information receiver to receive reference signal information on one or more of reference signal transmission periods and offsets from a Base Station (BS) within a coordinated BS set;
a reference signal transmission period and offset determiner to determine a reference signal transmission period and offset for a corresponding BS by using the received reference signal information configured such that the reference signal is not simultaneously transmitted in a subframe in which the reference signal is transmitted to another BS within the coordinated BS set; and
a reference signal transmitter to transmit the reference signal in a corresponding subframe according to the determined reference signal transmission period and offset.
